(19) United States
(12) Patent Application Publication
(10) Pub. No.: US 2011/0207401 A1
(43) Pub. Date: Aug. 25, 2011

(54) DISPLAY DEVICE AND DISPLAY SYSTEM AND EXTERNAL DEVICE DETECTING METHOD THEREOF

(75) Inventors: Youngsun HAN, Suwon-si (KR); Taeseon KIM, Hwaseong-si (KR); Min-Woo LEE, Suwon-si (KR)

(73) Assignee: SAMSUNG ELECTRONICS CO., LTD., Suwon-si (KR)

(21) Appl. No.: 12/957,909

(22) Filed: Dec. 1, 2010

(30) Foreign Application Priority Data
Feb. 24, 2010 (KR) 10-2010-0016723

(51) Int. Cl. H04B 5/00

(52) U.S. Cl. 455/41.1

(57) ABSTRACT

Provided are a display device, a display system, and an external device detecting method thereof. The display device includes a display unit which detects a position of an external device including a near field communication (NFC) device and includes a plurality of NFC tags, a plurality of sensors which sense at least one of current, voltage, and power of an NFC tag enabled by the external device among the NFC tags, and a determination unit which determines a position of an NFC tag adjacent to the external device based on sensing results of the sensors.

### CROSS-REFERENCE TO RELATED APPLICATION

This application claims priority from Korean Patent Application No. 10-2010-0016723, filed on Feb. 24, 2010, the entire disclosure of which is hereby incorporated by reference.

### SUMMARY

Exemplary embodiments relate to display devices and, more particularly, to a display device and a display system which are capable of detecting an external device and an external device detecting method thereof.

According to an aspect of an exemplary embodiment, there is provided a display device for detecting a position of an external device including a near field communication (NFC) device, the display device including first conductive lines extending in a first direction; second conductive lines extending in a second direction; and a plurality of NFC tags disposed at intersections of the first conductive lines and the second conductive lines. The position of the external device is detected by sensing at least one of current, voltage, and power of an NFC tag enabled by the external device among the NFC tags.

The display device may further include first sensors connected to the first conductive lines and configured to sense at least one of current, voltage, and power corresponding to the enabled NFC tag; and second sensors connected to the second conductive lines and configured to sense at least one of current, voltage, and power corresponding to the enabled NFC tag.

The display device may further include a determination unit configured to determine row information of the enabled NFC tag based on sensing results of the first sensor and determine column information of the enabled NFC tag based on sensing results of the second sensors.

When there are at least two NFC tags enabled by the external device among the NFC tags, the determination unit may determine row information of a selected one of the at least two NFC tags by comparing the sensing results of the first sensors with a reference value and determine column information of a selected one of the least two NFC tags by comparing the sensing result of the second sensors with the reference value.

When a sensing result of a specific sensor, among the sensing results of the first or second sensors, is greater than the reference value, the determination unit may select an NFC tag corresponding the specific sensor among the at least two enabled NFC tags.

At least one of a peer-to-peer (P2P) communication function, a radio frequency identification (RFID) function, and a card emulation function may be performed between the external device and the NFC tag enabled by the external device.

According to an aspect of another exemplary embodiment, there is provided a display system including an external device including an NFC device; and a display device detecting a position of the external device. The display device may include a display unit including a plurality of NFC tags; a plurality of sensors configured to sense at least one of current, voltage, and power of an NFC tag enabled by the external device; and a determination unit configured to determine a position of the NFC tag enabled by the external device based on sensing results of the sensors.

The display unit may further include conductive lines coupled between the NFC tags and the sensors. The conductive lines may include first conductive lines extending in a row direction and second conductive lines extending in a column direction. The first and second conductive lines may be each arranged at regular intervals.

The NFC tags may be disposed at intersections of the first conductive lines and the second conductive lines.

The sensors may include first sensors connected to the first conductive lines and second sensors connected to the second conductive lines. The determination may determine row information of the NFC tag enabled by the external device based on sensing results of the first sensors and determine column information of the NFC tag enabled by the external device based on sensing results of the second sensors.

When there are at least two NFC tags enabled by the external device among the NFC tags, the determination unit may determine a selected one of the at least two enabled NFC tags by comparing sensing results of the sensors with a reference value.

When a sensing result of a specific sensor of the sensors is greater than the reference value, the determination unit may select an NFC tag corresponding to the specific sensor among the at least two enabled NFC tags.

The display unit may further include conductive lines connected to the NFC tags in one-to-one correspondence. The sensors may sense at least one of current, voltage, and power transferred through the conductive lines.

The NFC tags may be disposed a front surface or a back surface of the display unit.

According to example embodiments of the inventive concept, at least one of a P2P communication function, an RFID function, and a card emulation function may be performed between the external device and the NFC tag enabled by the external device.

According to an aspect of an exemplary embodiment, there is provided a method for detecting a position of an external device with an NFC device mounted thereon, the method including enabling a predetermined one of a plurality of NFC tags in response to the external device; and detecting a position of the external device by sensing at least one of current, voltage, and power of the enabled NFC tag.

The NFC tags may be disposed at intersections of first conductive lines extending in a first direction and second conductive lines extending in a second direction. The detecting the position of the external device may include determining row information of the enabled NFC tag based on a sensing result sensed through the first conductive lines; and determining column information of the enabled NFC tag based on a sensing result sensed through the second conductive lines.

The method may further include comparing each of sensing results corresponding to at least two NFC tags with a reference when the at least two NFC tags are enabled among the NFC tags.

When, among the sensing results corresponding to the at least two NFC tags, a sensing result corresponding to a specific enabled NFC tag is greater than a reference value, a position of the external device may be detected based on position information of the specific enabled NFC tag.

The NFC tags may be connected to a plurality of conductive lines in one-to-one correspondence. The detecting the position of the external device may include detecting a position of the external device based on position information of an NFC tag corresponding to an enabled one of the conductive lines.

### BRIEF DESCRIPTION OF THE DRAWINGS

The above and/or other aspects will become more apparent from the following description of the exemplary embodiments, taken in conjunction with the accompanying drawings, in which:

FIG. 1 is a block diagram of a display device according to an exemplary embodiment;

FIG. 2 is a block diagram for detailed description of the display device shown in FIG. 1;

FIG. 3 is a block diagram illustrating the operation of the display device shown in FIG. 1;

FIG. 4 is a flowchart illustrating the operation of the display device shown in FIG. 3;

FIG. 5 is a block diagram illustrating operation of the display device shown in FIG. 1;

FIG. 6 is a flowchart illustrating operation of the display device shown in FIGS. 5; and

FIG. 7 is a block diagram of a display device according to another exemplary embodiment.

### DETAILED DESCRIPTION OF EXEMPLARY EMBODIMENTS

The inventive concept will now be described more fully hereinafter with reference to the accompanying drawings, in which preferred embodiments of the inventive concept are shown. The embodiments depicted therein are provided by way of example, not by way of limitation, wherein like reference numerals refer to the same or similar elements. The drawings are not necessarily to scale, emphasis instead being placed upon illustrating aspects of the inventive concept.

Touch screen technologies are increasingly being used in display devices to sense images selected by a user. A display device using a touch screen technology senses a user's contact to detect a display image selected by the user. However, touch screen technologies may have a limitation in application to various fields due to high cost of a touch screen panel.

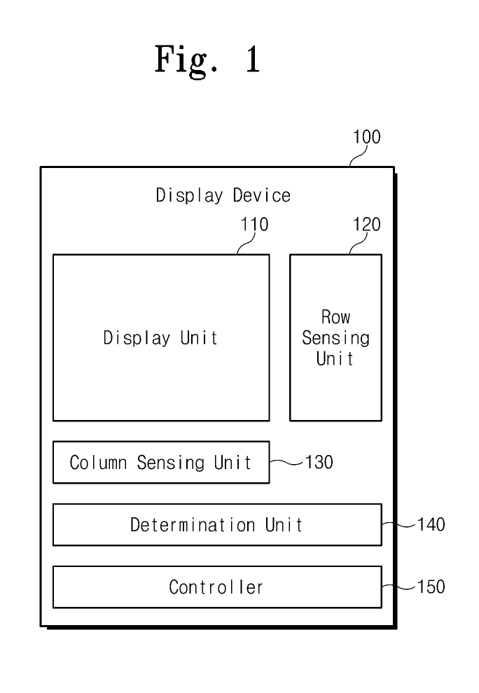

FIG. 1 is a block diagram of a display device 100 according to an exemplary embodiment. The display device 100 includes a display unit 110, a row sensing unit 120, a column sensing unit 130, a determination unit 140, and a controller 150.

The display unit 110 provides a display image to an external entity. For example, the display unit 110 provides at least two display images to be selected by a user.

The display unit 110 includes a plurality of near field communication (NFC) tags. The NFC tag is a predetermined NFC device or chip that may operate as a passive tag. The NFC tags correspond to display images displayed on the display unit 110, respectively. The display unit 110 determines a position of an enabled NFC tag to sense a display image selected by a user.

More specifically, NFC is a radio frequency identification (RFID) technology in which short range non-contact wireless communication enables a mobile communication terminal or a personal computer (PC) to exchange data between devices at a short distance. This technology uses low power and a frequency of 123.56 MHz.

When a portable terminal with an NFC device mounted thereon approaches the display unit 110, an induced electromotive force is generated between the NFC device and an NFC tag approaching the portable terminal. That is, the NFC tag adjacent to the portable terminal may be enabled.

In this case, the display device 100 may sense at least one of current, voltage, and power generated by the induced electromotive force to determine a position of the enabled NFC tag. In other words, the display device 100 determines a display image adjacent to the portable terminal among the display images displayed on the display unit 110.

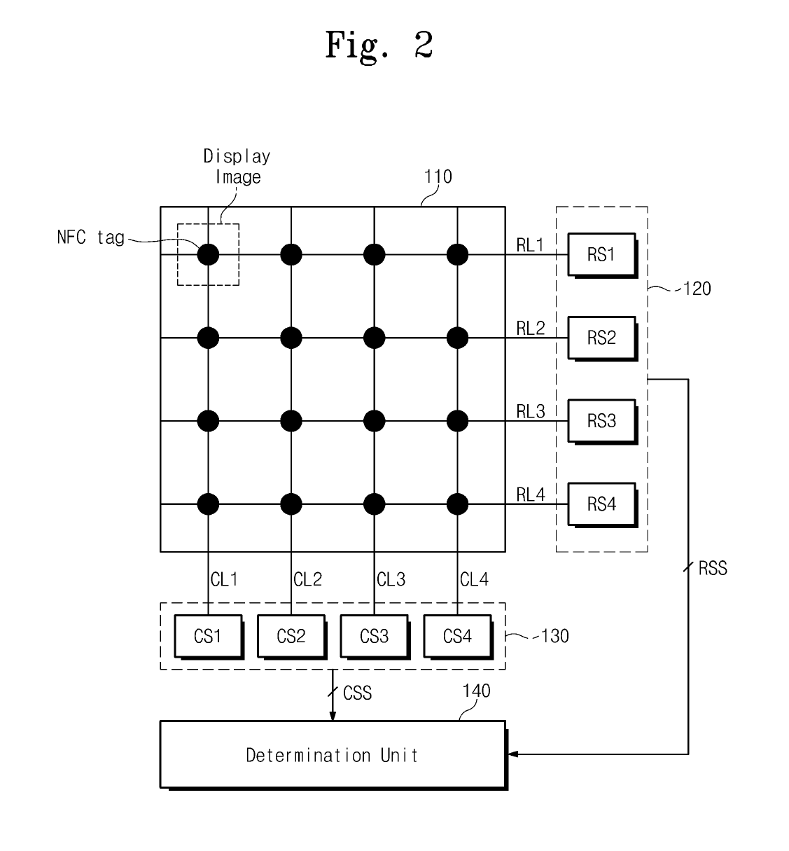

The NFC tag may be disposed at a front surface or a side surface of the display unit 110. In addition, the NFC tag may include an image tag, an RFID tag, and so forth. The display unit 110 will be described in detail later with reference to FIG. 2.

The row sensing unit 120 and the column sensing unit 130 are connected to the display unit 110. For example, the row sensing unit 120 and the column sensing unit 130 may be connected to NFC tags of the display unit 110 through a conductive line. The row sensing unit 120 and the column sensing unit 130 may sense at least one of current, voltage, and power corresponding to the enabled NFC tag.

More specifically, when the portable terminal with an NFC device mounted thereon approaches the display unit 110, the row selecting unit 120 and the column selecting unit 130 may sense at least one of current, voltage, and power generated by an induced electromotive force. For example, the row selecting unit 120 and the column selecting unit 130 may sense current generated by an induced electromotive force. The row selecting unit 120 and the column selecting unit 130 may transmit a column sensing signal CSS and a row sensing signal RSS corresponding to the sensed current to the determination unit 140, respectively. The row sensing unit 120 and the column sensing unit 130 will be described in detail later with reference to FIG. 2.

The determination unit 140 is connected to the row sensing unit 120 and the column sensing unit 130. The determination unit 140 receives a column sensing signal CSS and a row sensing signal RSS from the row sensing unit 120 and the column sensing unit 130, respectively. The determination unit 140 determines a position of an enabled NFC tag, based on the column sensing signal CSS and the row sensing signal RSS.

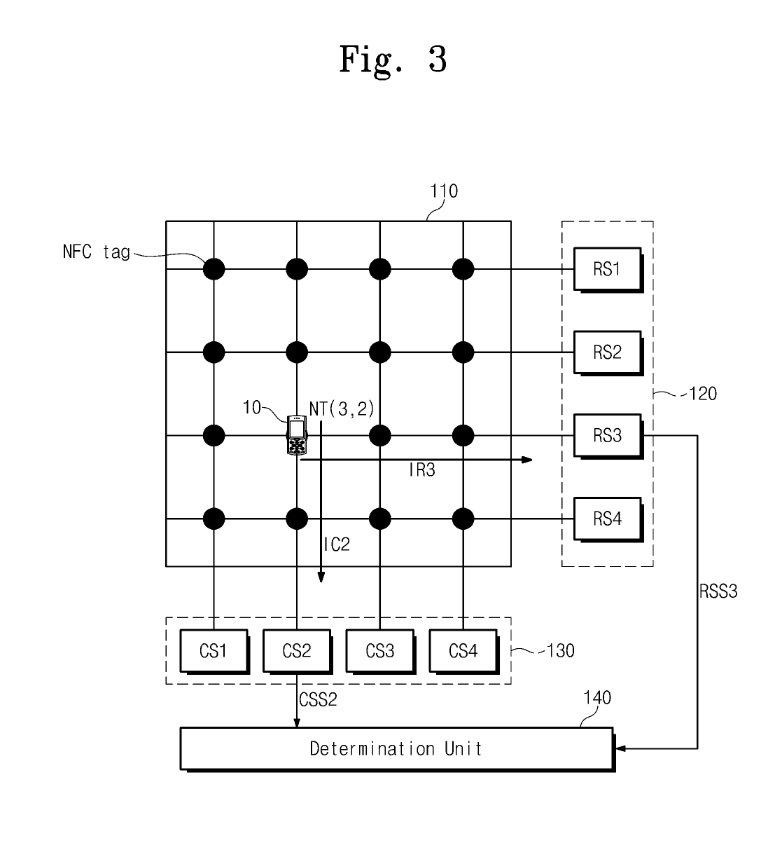

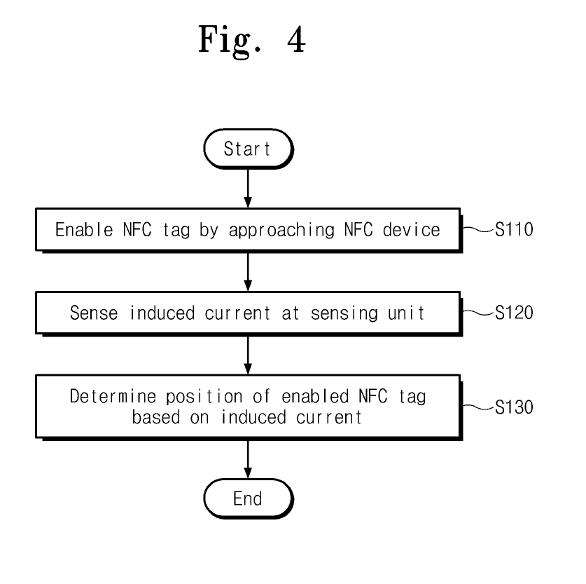

More specifically, when a portable terminal with an NFC device mounted thereon approaches the display unit 110, an NFC tag adjacent to the portable terminal may be enabled. For example, when an NFC tag adjacent to the portable terminal is enabled, the determination unit 140 may determine a position of the enabled NFC tag based on received column and row sensing signals CSS and RSS. This will be described in detail later with reference to FIGS. 3 and 4.

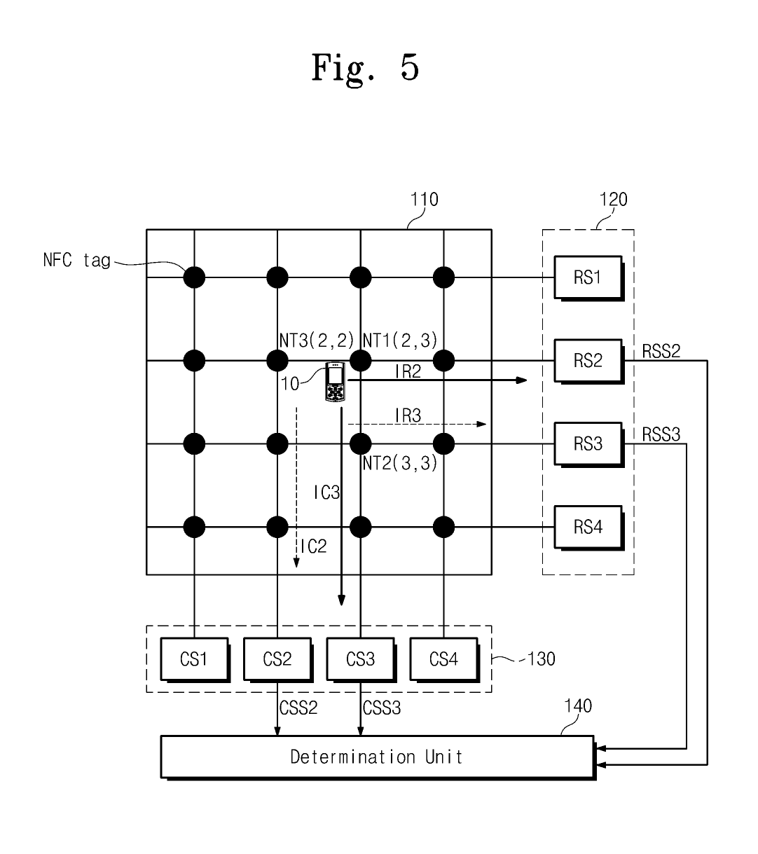

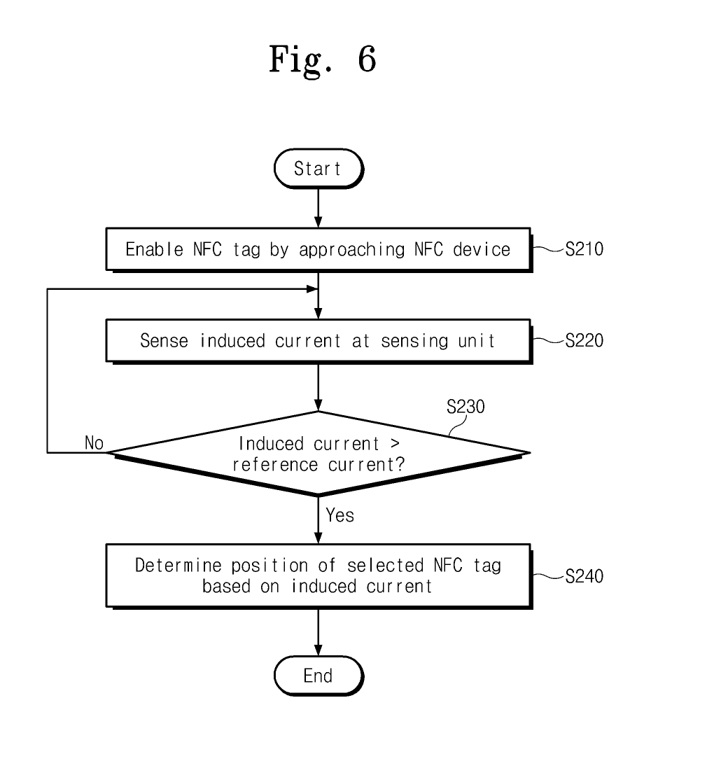

As another example, when at least two NFC tags adjacent to the portable terminal are enabled, the determination unit 140 receives at least two column sensing signals CSS and at least two row sensing signals RSS from the row sensing unit 120 and the column sensing unit 130, respectively. In this case, the determination unit 140 may compare each of the received column and row sensing signals CSS and RSS with a reference signal RS to determine a position of a selected one of enabled NFC tags. This will be described in detail later with reference to FIGS. 5 and 6.

The controller 150 receives position information of the enabled NFC tag from the determination unit 140. The controller 150 may control an overall operation of the display device 100 by using the position information of the enabled NFC tag and a corresponding display image.

For example, the controller 150 may control the display device 100 to detect a display image corresponding to an enabled NFC tag among display images displayed on the display unit 110. In other words, the controller 110 may control the display device 100 to operate similarly to a touch screen. However, the display device 100 according to the embodiments of the inventive concept may make a short range non-contact wireless communication, unlike a touch screen.

As another example, the controller 150 may control the display device 100 to transmit/receive data between an NFC device of a portable terminal and an enabled NFC tag. For example, when two or more NFC tags are enabled, the controller 150 may control the display device 100 to transmit/receive data between a selected one of enabled NFC tags and an NFC device of a portable terminal. In other words, the controller 150 may control the display device 100 to prevent data transmission between an unselected one of the enabled

NFC tags and the NFC device of a portable device.

It will be understood that a peer-to-peer (P2P) function, an RFID read function or a card emulation function may be executed between a selected NFC tag and an NFC device of a portable terminal.

FIG. 2 is a block diagram for detailed description of the display device 100 shown in FIG. 1.

Referring to FIG. 2, the display unit 110 includes a plurality of NFC tags and a plurality of conductive lines RL1˜RL4 and CL1˜CL4. The conductive lines are arranged to be spaced at regular intervals, and the NFC tags are electrically connected to the conductive lines, respectively. For example, the conductive lines RL1˜RL4 extend in a row direction and are arranged at regular intervals, and the conductive lines CL1˜CL4 extend in a column direction and are arranged at regular intervals. In addition, the NFC tags are disposed at intersections of the conductive lines RL1˜RL4 and the conductive lines CL1˜CL4. The NFC tags correspond to display images, respectively.

The display unit 110 provides a user the display images corresponding to the NFC tags. The user may select one of the display images. For example, the user may select a display image by approaching a portable terminal with an NFC device mounted thereon to the display image. In this case, an NFC tag corresponding to the display image may be enabled.

The row sensing unit 120 and the column sensing unit 130 include a plurality of row sensors RS and a plurality of column sensors CS, respectively. For example, it will be assumed in FIG. 2 that the row sensing unit 120 includes first to fourth row sensors RS1˜RS4 and the column sensing unit 130 includes first to fourth column sensors CS1˜CS4.

The row sensing unit 120 and the column sensing unit 130 are connected to the display unit 110 through conductive lines. More specifically, the row sensors RS and the column sensors CS are connected to NFC tags through the conductive lines RL1˜RL4 and the conductive lines CL1˜CL4, respectively.

Each of the row sensors RS and the column sensors CS senses at least one of current, voltage, and power generated by an enabled NFC tag. The row sensors RS and the columns sensors CS transfer a column sensing signal CSS and a row sensing signal RSS corresponding to the sensed current or the like to a determination unit (140 in FIG. 1). The operation of a display device shown in FIG. 1 according to an exemplary embodiment will be described below in detail with reference to FIGS. 3 to 6.

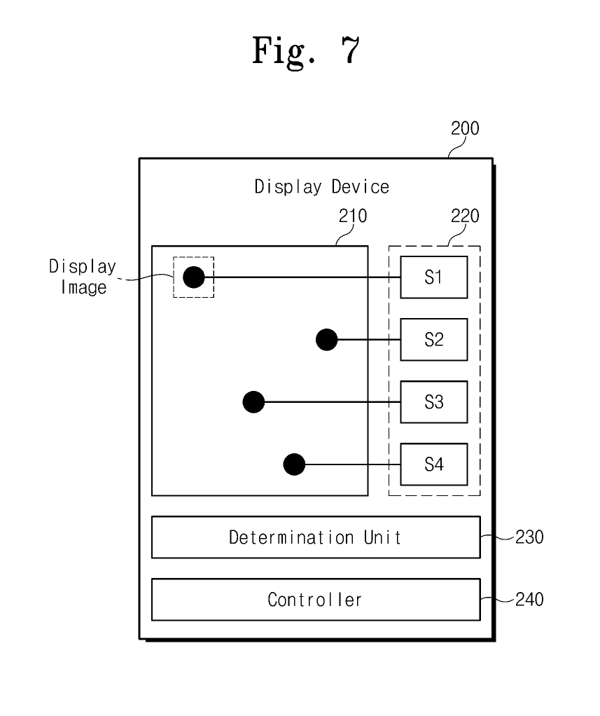

It will be understood that the above description is merely exemplary. For example, while NFC tags disposed at conductive lines arranged at regular intervals are shown in FIG. 2, the inventive concept is not limited thereto. For example, an NFC tag may be disposed variously according to its use. This will be described in detail later with reference to FIG. 7.

FIG. 3 is a block diagram illustrating operation of the display device shown in FIG. 1. For example, it will be assumed in FIG. 3 that one NFC tag is enabled. In addition, for brevity of explanation, it will be assumed that a display unit 110 includes a plurality of NFC tags disposed in a 4×4 matrix and a row sensing unit 120 and a column sensing unit 130 sense induced current generated by an inducted electromotive force.

Referring to FIG. 3, for example, it will be assumed that a portable terminal 10 with an NFC device mounted thereon approaches an NFC tag NT having a coordinate (3, 2). The coordinate (3, 2) means that the NFC tag NT is disposed at an intersection of a third conductive line RL3 among conductive lines in a row direction and a second conductive line CL2 among conductive lines in a column direction.

When the portable terminal 10 with an NFC device mounted thereon approaches an NFC tag NT, an induced electromotive force is generated between the NFC device of the portable terminal 10 and an NFC tag of the display unit 110 such that the NFC tag NT is enabled. In this case, inducted current is generated at the NFC tag NT and the conductive lines connected to the NFC tag NT. The induced current is transferred to the row sensing unit 120 and the column sensing unit 130 along the conductive lines connected to the NFC tag NT.

The row sensing unit 120 receives row current IR from the display unit 110. The row sensing unit 120 provides a row sensing signal RSS corresponding to the received row current IR to a determination unit 140. In this case, the row sensing signal RSS may include row position information of an enabled NFC tag.

For example, referring to FIG. 3, a third row sensor RS3 may receive third row current IR3 from the display unit 110 and provide a third row sensing signal RSS3 corresponding to the third row current IR3 to a determination unit 140. In this case, the third row sensing signal RSS3 may include row position information indicating that an enabled NFC tag NT is positioned at a conductive line of a third row among conductive lines in a row direction.

The column sensing unit 130 receives column current IC from the display unit 110. The column sensing unit 130 provides a column sensing signal CSS corresponding to the received column current IC to the determination unit 140. In this case, the column sensing signal CSS may include column position information of an enabled NFC tag NT.

A second column sensor CS2 may receive second column current IC2 from the display unit 110 and provide a second row sensing signal CSS2 corresponding to the second column current IC2 to the determination unit 140. In this case, the second column sensing signal CSS2 may include column position information indicating that an enabled NFC tag NT is positioned at a conductive line of a second column among conductive lines in a column direction.

The determination unit 140 receives a row sensing signal RSS and a column sensing signal CSS from the row sensing unit 120 and the column sensing unit 130, respectively. The determination unit 140 determines a position of an enabled NFC tag NT, based on the row sensing signal RSS and the column sensing signal CSS.

For example, referring to FIG. 3, the determination unit 140 receives a third row sensing signal RSS3 and a second column sensing signal CSS2 from the third row sensor RS3 and the second column sensor CS2, respectively. Since the third row sensing signal RSS3 and the second column sensing signal CSS2 include row information and column information of an enabled NFC tag NT respectively, the termination unit 140 may determine that the NFC tag NT is positioned at the coordinate (3,2).

As set forth above, a display device according to exemplary embodiments may determine position information of an enabled NFC device among NFC devices of a display unit 110. Thus, the display device according to exemplary embodiments may detect a display image selected by a user among display images displayed on a display unit.

It will be understood that the above description is merely exemplary. For example, while the portable terminal 10 shown in FIG. 3 is a cellular phone, it is not limited thereto. For example, the portable terminal 10 may include all mobile communication terminals capable of mounting an NFC device thereon such as cellular phones, PCS terminals, personal mobile PMP terminals, personal digital assistant (PDA) terminals, and notebook computers.

FIG. 4 is a flowchart illustrating operation of the display device shown in FIG. 3.

At S100, an NFC tag is enabled. That is, when an NFC device approaches the NFC tag, the NFC tag adjacent to the NFC device is enabled. The NFC device may be an NFC device mounted on a portable terminal such as a cellular phone. In this case, for example, referring to FIG. 3, induced current may be generated at an NFC tag adjacent to an NFC device.

At S120, induced current is sensed at a sensing unit. For example, referring to FIG. 3, a row current IR of induced current may be sensed at the row sensing unit 120. In addition, a column current IC of the induced current may be sensed at the column sensing unit 130.

At S130, a position of the enabled NFC tag is determined based on sensed induced current. For example, referring to FIG. 3, the row sensing unit 120 may transmit a row sensing signal RSS corresponding to the sensed row current IR to the determination unit 140. The column sensing unit 130 may transmit a column sensing signal CSS corresponding to sensed column current IC to the determination unit 140.

In this case, the row sensing signal RSS and the column sensing signal CSS include row position information and column position information of the enabled NFC tag, respectively. Accordingly, the determination unit 140 may determine the position of the enabled NFC tag, based on the row sensing signal RSS and the column sensing signal CSS.

FIG. 5 is a block diagram illustrating the operation of the display device shown in FIG. 1. For example, it will be assumed in FIG. 5 that three NFC tags are enabled. For brevity of explanation, it will be assumed that a display unit 110 includes a plurality of NFC tags arranged in a 4×4 matrix and a row sensing unit 120 and a column sensing unit 130 sense induced current generated by an induced electromotive force

Referring to FIG. 5, it is assumed that a portable terminal 100 with an NFC device mounted thereon approaches a first NFC tag NT1. That is, it is assumed that a user selects the first NFC tag NT1. When the portable terminal 100 approaches the first NFC tag NT1, the first NFC tag NT1 is enabled. In this case, induced current may be generated at the first NFC tag NT1 and conductive lines connected to the first NFC tag NT1.

Moreover, in this case, not only the first NFC tag NT1 but also NFC tags adjacent to the first NFC tag NT1 may be enabled. For example, in the case that NFC tags are arranged on a display unit at small intervals, not only an NFC tag selected by a user but also NFC tags adjacent to the selected NFC tag may be enabled.

For example, referring to FIG. 5, a first NFC tag NT1 selected by a user as well as second and third NFC tags NT2 and NT3 adjacent to the first NFC tag NT1 may be enabled. In this case, induced current may be generated at the second NFC tag NT2 and conductive lines connected to the second NFC tag NT2, and induced current may be generated at the third NFC tag NT3 and conductive lines connected to the third NFC tag NT3.

As a result, when the portable terminal 10 with an NFC device mounted thereon approaches the first NFC tag NT1, the first, second and third NFC tags NT1, NT2 and NT3 may be enabled. In this case, a second row current IR2 and third row current IR3 may be transferred to the row sensing unit 120, and a second column current IC2 and a third column current IC3 may be transferred to the column sensing unit 130.

An induced electromotive force of the first NFC tag NT1 selected by the user is greater than that of the second and third NFC tags NT2 and NT3 unselected by the user. Thus, the intensity of the second row current IR2 corresponding to the first NFC tag NT1 may be greater than that of the third row current IR3. Similarly, the intensity of the third column current IC3 corresponding to the first NFC tag NT1 may be greater than that of the second column current IC2.

The row sensing unit 120 receives row currents IR from the display unit 110. The row sensing unit 120 provides row sensing signals corresponding to the received row currents IR to the determination unit 140. In this case, the row sensing signals RSS may include row position information of enabled NFC tags NT. In addition, the row sensing signals RSS may include information on the intensities of the received row currents IR.

For example, referring to FIG. 5, the second row sensor RS2 may receive the second row current IR2 and transmit a second row sensing signal RSS2 corresponding to the second row current IR2 to the determination unit 140. In this case, the second row sensing signal RSS2 may include row position information indicating that the enabled first and third NFC tags NT1 and NT3 are positioned at a conductive line of a second row among conductive lines in a row direction. In addition, the second row sensing signal RSS2 may include information on the intensity of the received second row current IR2.

Similarly, the third row sensor RS3 may receive the third row current IR3 and transmit a third row sensing signal RSS3 corresponding to the third row current IR3 to the determination unit 140. In this case, the third row sensing signal RSS3 may include row position information indicating that the enabled second NFC tag NT2 is positioned at a conductive line of a third row among the conductive lines in the row direction. In addition, the third row sensing signal RSS3 may include information on the intensity of the received third row current IR3.

The column sensing unit 130 receives column currents IC from the display unit 110. The column sensing unit 130 provides column sensing signals CSS corresponding to the received column currents IC to the determination unit. In this case, the column sensing signals CSS may include column position information of enabled NFC tags. In addition, the column sensing signals CSS may include information on the intensity of the received column current IC.

For example, referring to FIG. 5, second and third column sensors CS2 and CS3 may receive second and third column currents IC2 and IC3 and transmit second and third column sensing signals CSS2 and CSS3 to the determination unit 140, respectively. This is similar to the above-described operation of the row sensor RS and will not be described in further detail. However, the second and third column sensing signals CSS2 and CSS3 may include not only column position information of the enabled NFC tags but also information on the intensities of the second and third column currents IC2 and IC3, respectively.

The determination unit 140 receives row sensing signals RSS and column sensing signals CSS from a row sensing unit 120 and a column sensing unit 130, respectively. The determination unit 140 determines a position of an enabled NFC tag selected by a user among the enabled NFC tags, based on the row sensing signals RSS and the column sensing signals CSS.

More specifically, the determination unit 140 receives a plurality of row sensing signals RSS from the row sensing unit 120. In this case, the determination unit 140 determines row information of an NFC tag selected by a user by comparing the intensity of row currents IR corresponding to the row sensing signals RSS with the intensity of reference current.

When the intensity of the row current IR is greater than that of the reference current, the determination unit 140 determines an NFC tag corresponding to the row current IR as an NFC tag selected by a user. On the other hand, when the intensity of the row current IR is smaller than that of the reference current, the determination unit 140 determines the NFC tag corresponding to the row current IR as an NFC tag unselected by the user. In this case, the intensity of the reference current may be suitably selected to be smaller than that of row current selected by the user and greater than that of row current unselected by the user.

For example, referring to FIG. 5, the determination unit 140 may receive the second and third row sensing signals RSS2 and RSS3 from the second and third row sensors RS2 and RS3, respectively. In this case, the second and third row sensing signals RSS2 and RSS3 include information on the intensities of the second and third row currents IR2 and IR3, respectively. Accordingly, the determination unit 140 may compare the intensities of the second and third row currents IR2 and IR3 with the intensity of reference current, based on the second and third row sensing signals RSS2 and RSS3.

In this case, the intensity of the second row current IR2 may be greater than that of the reference current. This is because the intensity of an induced electromotive force corresponding to a first NFC tag NT1 is greater than that of an induced electromotive force corresponding to a second NFC tag NT2. That is, this is because a portable terminal with an NFC device mounted thereon is adjacent to the first NFC tag NT1.

Accordingly, the determination unit 140 may determine row information included in the second row sensing signal RSS2 as row information of an NFC tag selected by a user. That is, the determination unit 140 may determine that the NFC tag selected by the user is positioned at a conductive line of a second row among conductive lines in a row direction.

The intensity of the third row current IR3 may be smaller than that of the reference current. Accordingly, the determination unit 140 may determine the row information included in the third row sensing signal RSS3 as row information of an NFC tag unselected by the user.

Referring to FIG. 5, the determination unit 140 receives a plurality of column sensing signals CSS from the column sensing unit 130. In this case, the determination unit 140 determines column information of an NFC tag selected by the user by comparing the intensity of column currents IC corresponding to the column sensing signals CSS with the intensity of the reference current.

For example, referring to FIG. 5, the determination unit 140 may determine column information of an NFC tag selected by a user by comparing the intensity of the second third column current IC2 and IC3 with the intensity of the reference current. For example, when the intensity of the third column current IC is greater than that of the reference current and the intensity of the second column current IC2 is smaller than that of the reference current, the determination unit 140 may determine that column information included in the third column sensing signal CSS3 is column information of an NFC tag selected by a user. This is similar to the above-described operation of the determination unit 140 determining row information of the selected NFC tag and will not be described in further detail.

As a result, the determination unit 140 may determine row information and column information of a selected NFC tag by comparing the intensity of row current IR with the intensity of column current IC. For example, referring to FIG. 5, the determination unit 140 determines that an NFC tag selected by a user is positioned at a coordinate (2,3).

FIG. 6 is a flowchart illustrating the operation of the display device shown in FIG. 5.

At S210, an NFC tag is enabled when an NFC device approaches the NFC tag, the NFC tag adjacent to the NFC device is enabled. The NFC device may be an NFC device mounted on a portable terminal such as a cellular phone or the like. When the NFC device approaches the NFC tag, the NFC tag adjacent to the NFC device is enabled.

In this case, for example, referring to FIG. 5, not only a first NFC tag NT1 selected by the user but also second and third NFC tags NT2 and NT3 adjacent to the selected NFC tag may be enabled. Thus, induced current may be generated at the first, second and third NFC tags NT1, NT2 and NT3.

At S220, the induced current is sensed by a sensing unit. For example, referring to FIG. 5, second and third row currents IR2 and IR3 of the induced current may be sensed at the row sensing unit 120. In addition, second and third column currents IC2 and IC3 of the induced current may be sensed at the column sensing unit 130.

In this case, the row sensing unit 120 may transmit second and third row sensing signals RSS2 and RSS3 corresponding to the received second and third row currents IR2 and IR3 to the determination unit 140. In addition, the column sensing unit 130 may transmit second and third column sensing signals CSS2 and CSS3 corresponding to the received second third column currents IC2 and IC3 to the determination unit 140. In this case, the row sensing signal RSS and the column sensing signal CSS may include information on the intensity of corresponding row current IR and information on the intensity of corresponding column current IC, respectively.

At S230, it is determined whether the intensity of the induced current is greater than that of reference current. For example, referring to FIG. 5, the determination unit 140 determines whether the intensity of the second row current IR2 and the third row current IR3 is greater than that of the reference current. Similarly, the determination unit 140 determines whether the intensity of the second column current IC2 and the third column current IC3 is greater than that of the reference current.

When it is determined that the intensity of induced current is greater than that of the reference current, a position corresponding to an NFC tag selected by a user is determined (S240).

For example, referring to FIG. 5, the intensity of the second row current IR2 is greater than that of the reference current. Accordingly, the determination unit 140 determines that the NFC tag selected by the user is positioned at a second conductive line among conductive lines in a row direction. In addition, the intensity of the third column current IC3 is greater than that of the reference current. Accordingly, the determination unit 140 determines that the NFC tag selected by the user is positioned at a third conductive line among conductive lines in a column direction. As a result, the determination unit 140 determines that the NFC tag selected by the user is positioned at a coordinate (2,3).

On the other hand, when the intensity of the induced current is smaller than that of the reference current, the determination unit 140 may determines that an NFC tag corresponding to the induced current as an NFC tag unselected by the user.

FIG. 7 is a block diagram of a display device according to another exemplary embodiment. The display device shown in FIG. 7 is similar to that shown in FIG. 1. Therefore, their differences will be intensively described below.

Referring to FIG. 7, a display device 200 includes a display unit 210, a sensing unit 220, a determination unit 230, and a controller 240.

The display unit 210 includes a plurality of NFC tags. The NFC tags correspond to display images, respectively. The display unit 210 includes at least two display images to be selected by a user.

NFC tags of the display unit 110 shown in FIG. 1 are disposed at intersections of conductive lines arranged at regular intervals. For example, referring to FIG. 2, conductive lines of a display unit 110 are arranged in a matrix to be spaced at regular intervals, and NFC tags are disposed at intersections of the conductive lines. Unlike this, the NFC tags of the display unit 210 shown in FIG. 7 are disposed at random and each connected to one conductive line.

When the portable terminal with an NFC device mounted thereon approaches an NFC tag of the display unit 210, induced current may be generated at the NFC tag and a conductive line connected to the NFC tag. This is similar to the display unit 110 shown in FIG. 1 and will not be described in further detail.

Continuing to refer to FIG. 7, the sensing unit 220 is connected to the display unit 210. For example, the sensing unit 220 includes first to fourth sensors SI˜S4 and each sensor S is connected to an NFC tag. The sensor unit 220 may sense at least one of current, voltage, and power generated at the NFC tag.

The display device 100 shown in FIG. 1 includes a row sensing unit 120 and a column sensing unit 130. Thus, the display device 100 may determine row position information and column position information of an NFC tag selected by a user. Unlike the display device 100, the display device 200 shown in FIG. 7 includes a sensing unit 220 including sensors S which are connected to NFC tags in one-to-one correspondence. Since the sensors S are connected to the NFC tags in one-to-one correspondence, the display device 200 shown in FIG. 7 may determine position information of the NFC tag selected by the user.

When the portable terminal with an NFC device mounted thereon approaches an NFC tag of the display unit 210, the sensing unit 220 senses induced current through the selected NFC tag and the conductive line connected to the selected NFC tag. The sensing unit 220 may transmit a sensing signal SS corresponding to the received induced current to the determination unit 230. The operation of the sensing unit 220 is similar to that of the row sensing unit 120 or the column sensing unit 132 shown in FIG. 1 and will not be described in further detail.

The determination unit 230 is connected to the sensing unit 220. For example, the determination unit 230 may receive the sensing signal SS from the sensing unit 220. The determination unit 230 may determine position information of the NFC tag selected by the user, based on the sensing signal SS. The operation of the determination unit 230 is similar to that of the determination unit 140 shown in FIG. 1 and will not be described in further detail.

The controller 240 may control an overall operation of the display device 200. The operation of the controller 240 is similar to that of the controller 150 shown in FIG. 1 and will not be described in further detail.

As set forth above, a display device according to exemplary embodiments may determine position information of an NFC device selected by a user among NFC devices of a display unit. In other words, when the user approaches a portable terminal with an NFC device mounted thereon to a predetermined one of display images, the display device according to exemplary embodiments may detect a display image selected by the user.

It will be understood that NFC tags disposed at a display device according to the exemplary embodiments may perform intrinsic functions of an NFC device. For example, when a user select a predetermined NFC tag by using a portable terminal with an NFC device mounted thereon, NFC intrinsic functions may be performed between the selected NFC tag and the portable terminal. More specifically, a P2P function, an RFID read function or a card emulation function may be performed between the selected NFC tag and the NFC device mounted on the portable terminal.

As explained above, a display device according to exemplary embodiments includes a plurality of NFC tags. Therefore, a user can select a display image corresponding to an NFC tag by using a portable terminal with an NFC device mounted thereon. Thus, the display device can be implemented at lower cost than a touch screen because of use of the NFC tags.

While exemplary embodiments have been described with reference to the drawings, it will be apparent to those skilled in the art that various changes and modifications may be made without departing from the spirit and scope of the inventive concept. Therefore, it should be understood that the above embodiments are not limiting, but illustrative. Thus, the scope of the claims is to be determined by the broadest permissible interpretation and their equivalents, and shall not be restricted or limited by the foregoing description.

What is claimed is:

1. A display device for detecting a position of an external device comprising a near field communication (NFC) device, the display device comprising:
a plurality of first conductive lines extending in a first direction;
a plurality of second conductive lines extending in a second direction;
a plurality of NFC tags disposed at intersections of the plurality of first conductive lines and the plurality of second conductive lines; and
a determination unit which determines a position of the external device based on at least one of current, voltage, and power of an NFC tag which is enabled by the external device among the plurality of NFC tags.

2. The display device of claim 1, further comprising:
a plurality of first sensors which are connected to the plurality of first conductive lines and sense at least one of current, voltage, and power corresponding to the enabled NFC tag; and
a plurality of second sensors which are connected to the plurality of second conductive lines and sense at least one of current, voltage, and power corresponding to the enabled NFC tag.

3. The display device of claim 2, wherein the determination unit determines row information of the enabled NFC tag based on sensing results of the plurality of first sensors and determines column information of the enabled NFC tag based on sensing results of the plurality of second sensors.

4. The display device of claim 3, wherein:
when at least two NFC tags are enabled by the external device among the plurality of NFC tags, the determination unit determines row information of a selected one of the at least two NFC tags by comparing the sensing results of the plurality of first sensors with a reference value and determines column information of a selected one of the least two NFC tags by comparing the sensing results of the plurality of second sensors with the reference value.

5. The display device of claim 4, wherein:
when a sensing result of a specific sensor, among the sensing results of the first sensors or the second sensors, is greater than the reference value, the determination unit selects an NFC tag corresponding the specific sensor among the at least two enabled NFC tags.

6. The display device of claim 1, wherein:
at least one of a peer-to-peer (P2P) communication function, a radio frequency identification (RFID) function, and a card emulation function is performed between the external device and the NFC tag enabled by the external device.

7. A display system comprising:
an external device comprising a near field communication (NFC) device; and
a display device which detects a position of the external device,
wherein the display device comprises:
a display unit comprising a plurality of NFC tags;
a plurality of sensors which sense at least one of current, voltage, and power of an NFC tag enabled by the external device; and
a determination unit which determines a position of the enabled NFC tag based on sensing results of the plurality of sensors.

8. The display system of claim 7, wherein:
the display unit further comprises a plurality of first conductive lines extending in a row direction and arranged at regular intervals, and a plurality of second conductive lines extending in a column direction, the plurality of first conductive lines and the plurality of second conductive lines being coupled between the plurality of NFC tags and the plurality of sensors.

9. The display system of claim 8, wherein:
the plurality of NFC tags are disposed at intersections of the plurality of first conductive lines and the plurality of second conductive lines.

10. The display system of claim 9, wherein:
the plurality of sensors comprise a plurality of first sensors connected to the plurality of first conductive lines, and a plurality of second sensors connected to the plurality of second conductive lines; and
the determination unit determines row information of the NFC tag enabled by the external device based on sensing results of the plurality of first sensors and determines column information of the NFC tag enabled by the external device based on sensing results of the plurality of second sensors.

11. The display system of claim 7, wherein:
when at least two NFC tags are enabled by the external device among the plurality of NFC tags, the determination unit determines a selected one of the at least two enabled NFC tags by comparing the sensing results of the plurality of sensors with a reference value.

12. The display system of claim 11, wherein:
when a sensing result of a specific sensor of the plurality of sensors is greater than the reference value, the determination unit selects an NFC tag corresponding to the specific sensor among the at least two enabled NFC tags.

13. The display system of claim 7, wherein:
the display unit further comprises a plurality of conductive lines connected to the NFC tags in one-to-one correspondence, and
the plurality of sensors sense at least one of current, voltage, and power transferred through the plurality of conductive lines.

14. The display system of claim 7, wherein:
the plurality of NFC tags are disposed at a front surface or a back surface of the display unit.

15. The display system of claim 7, wherein:
at least one of a peer-to-peer (P2P) communication function, a radio frequency identification (RFID) function, and a card emulation function is performed between the external device and the NFC tag enabled by the external device.

16. A method for detecting a position of an external device comprising a near field communication (NFC) device, the method comprising:
enabling at least one of a plurality of NFC tags in response to the external device; and
detecting a position of the external device by sensing at least one of current, voltage, and power of the enabled NFC tag.

17. The method of claim 16, wherein:
the plurality of NFC tags are disposed at intersections of a plurality of first conductive lines extending in a first direction and a plurality of second conductive lines extending in a second direction; and
the detecting the position of the external device comprises:
determining row information of the enabled NFC tag based on sensing results sensed through the plurality of first conductive lines; and
determining column information of the enabled NFC tag based on sensing results sensed through the plurality of second conductive lines.

18. The method of claim 16, further comprising:
comparing each of sensing results corresponding to at least two NFC tags with a reference when the at least two NFC tags are enabled among the NFC tags.

19. The method of claim 18, wherein:
when, among the sensing results corresponding to the at least two NFC tags, a sensing result corresponding to a specific enabled NFC tag is greater than a reference value, a position of the external device is detected based on position information of the specific enabled NFC tag.

20. The method of claim 16, wherein:
the plurality of NFC tags are connected to a plurality of conductive lines in one-to-one correspondence; and
the detecting the position of the external device comprises:
detecting a position of the external device based on position information of an NFC tag corresponding to an enabled one of the plurality of conductive lines.
